(19) United States
(12) Patent Application Publication
(10) Pub. No.: US 2025/0350701 A1
(43) Pub. Date: Nov. 13, 2025

(54) INFORMATION PROCESSING DEVICE, TELEVISION RECEIVER, AND INFORMATION PROCESSING METHOD

(71) Applicant: SHARP KABUSHIKI KAISHA, Osaka (JP)

(72) Inventor: OSAMU SAKATSUJI, Osaka (JP)

(21) Appl. No.: 19/191,581

(22) Filed: Apr. 28, 2025

(30) Foreign Application Priority Data
May 7, 2024 (JP) 2024-075033
Feb. 21, 2025 (JP) 2025-026315

(51) Int. Cl. H04N 5/50; H04H 60/43

(52) U.S. Cl. CPC H04N 5/50; H04H 60/43

(57) ABSTRACT

An information processing device comprises a channel selection determiner that performs determination as to whether or not a channel is selectable; an incrementer that, in a case where a channel, on which the determination is made, is not selectable, increments a counter of the channel determined not to be selectable; and a determiner that, in a case where the counter exceeds a threshold value, determines that a channel, for which the counter exceeds the threshold value, is not receivable.

### CROSS-REFERENCE TO RELATED APPLICATIONS

The present application claims priority from Japanese Applications JP2024-075033 and JP2025-026315, the content to which is hereby incorporated by reference into this application.

### BACKGROUND OF THE INVENTION

### 1. Field of the Invention

The present disclosure relates to an information processing device, a television receiver, and an information processing method.

### 2. Description of the Related Art

Conventionally, there is known a technology relating to channel scan for determining whether or not a channel is selectable. For example, in the prior art, there is known a device that maintains registration as a selectable channel in a case where a channel that has been registered as a selectable channel because the channel was selectable in the past is determined not to be selectable in a newly performed channel scan.

### SUMMARY OF THE INVENTION

Even when a certain channel was selectable in the past, the channel may no longer be selectable due to, for example, the termination of a broadcast service. In this case, when a channel that can no longer be selected is left registered as a selectable channel, information such as a remote control key and an Electronic Programming Guide (EPG) remains on a device, which may interfere with user operation.

On the other hand, a situation in which a channel cannot be selected may become temporarily occur due to, for example, a temporary interruption of broadcast services or deterioration of radio wave conditions. In such a case, the channel becomes selectable again once the temporary cause is removed, and therefore it is appropriate to maintain the channel in a registered state as a selectable channel.

However, the device cannot determine whether a reason why the channel is not selectable is a permanent reason, such as the termination of broadcast services, or is a temporary reason, simply by determining whether or not the channel is selectable by channel scan.

The present disclosure has been made in view of the above problem. An object of the present disclosure is to provide an information processing device, a television receiver, and an information processing method that enable more appropriate management of a channel registration state in accordance with a broadcast service situation.

An information processing device according to an aspect of the present disclosure includes: a channel selection determiner that performs determination as to whether or not a channel is selectable; an incrementer that increments a counter of a channel determined not to be selectable in a case where the channel, on which the determination is made, is not selectable; and a determiner that determines a channel, for which the counter exceeds a threshold value, is not receivable, in a case where the counter exceeds the threshold value.

A television receiver according to an aspect of the present disclosure includes the above information processing device.

An information processing method according to an aspect of the present disclosure is an information processing method to be performed by an information processing device, and includes: performing determination as to whether or not a channel is selectable; incrementing a counter of a channel determined not to be selectable in a case where the channel, on which the determination is made, is not selectable; and determining that a channel, for which the counter exceeds a threshold value, is not receivable, in a case where the counter exceeds the threshold value.

According to the present disclosure, it is possible to provide an information processing device, a television receiver, and an information processing method that enable more appropriate management of a channel registration state in accordance with a broadcast service situation.

### BRIEF DESCRIPTION OF THE DRAWINGS

FIG. 1 is a functional block diagram illustrating a schematic configuration of a television receiver according to an embodiment.

FIG. 2 is a diagram illustrating an example of a channel scan result table stored in a channel scan data storage in FIG. 1.

FIG. 3 is a diagram illustrating an example of a registered channel table stored in the channel scan data storage in FIG. 1.

FIG. 4 is a functional block diagram illustrating a schematic configuration of a controller in FIG. 1.

FIG. 5 is a flowchart illustrating an example of a channel scan process executed by the controller in FIG. 1.

FIG. 6 is a flowchart illustrating an example of a channel recovery process executed by the controller in FIG. 1.

FIG. 7 is a diagram illustrating an example of a history information table stored in the channel scan data storage in FIG. 1.

FIG. 8 is a diagram illustrating another example of the channel scan result table stored in the channel scan data storage in FIG. 1.

FIG. 9 is a flowchart illustrating another example of the channel scan process executed by the controller in FIG. 1.

### DETAILED DESCRIPTION OF THE INVENTION

An embodiment of the present disclosure will be described with reference to the drawings. The embodiment described below is merely an example of the present disclosure, and the present disclosure is not limited to the embodiment. Even when an embodiment is other than the embodiment described below, various modifications may be made in accordance with design or the like, as long as the modifications do not deviate from the technical ideas of the present disclosure.

### Television Receiver

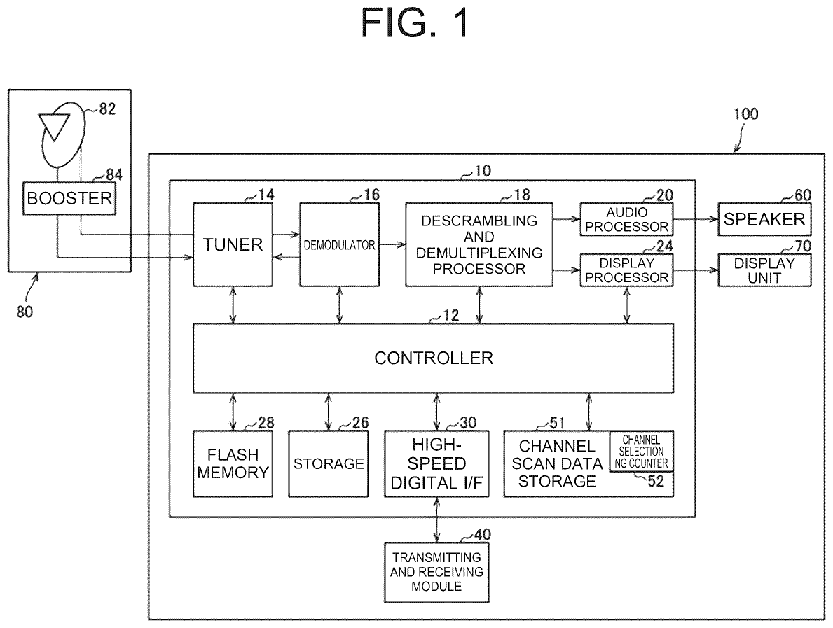

FIG. 1 is a functional block diagram illustrating a schematic configuration of a television receiver 100 according to the embodiment. The television receiver 100 acquires a television broadcast signal received by an antenna unit 80. The antenna unit 80 is an example of a receiver that can receive a television broadcast signal. The antenna unit 80 receives a broadcast signal contained in a broadcast wave sent from a broadcast station. The antenna unit 80 includes an antenna 82. The antenna unit 80 may include a booster 84, as illustrated in FIG. 1, if necessary. The antenna 82 receives, as a broadcast signal, an electrical signal generated by receiving an incoming broadcast wave. The antenna 82 is, for example, a parabolic antenna, a Yagi antenna, or the like. The antenna 82 outputs the received broadcast signal to the booster 84. The booster 84 amplifies the intensity of the broadcast signal input from the antenna 82 and outputs the amplified broadcast signal to the television receiver 100.

As illustrated in FIG. 1, the television receiver 100 according to this embodiment includes a main system 10, a transmitting and receiving module 40, a speaker 60, and a display unit 70. The television receiver 100 of this embodiment is connected to the external antenna unit 80. From a viewpoint of ensuring simplicity of the description, components that are not directly related to this embodiment will not be illustrated in the block diagram and the description thereof will also be omitted. However, the television receiver 100 may include omitted components depending on actual implementation.

In this embodiment, the main system 10 functions as an information processing device. The main system 10 processes a television broadcast signal input from the antenna unit 80, outputs audio indicated by the broadcast signal from the speaker 60, and outputs video indicated by the broadcast signal from the display unit 70. As illustrated in FIG. 1, the main system 10 includes, as functional blocks, a controller 12, a tuner 14, a demodulator 16, a descrambling and demultiplexing processor 18, an audio processor 20, a display processor 24, a storage 26, a flash memory 28, a high-speed digital I/F 30, and a channel scan data storage 51.

The controller 12 controls all parts of the television receiver 100. The controller 12 is composed of a control device such as a Central Processing Unit (CPU) and a Micro Processing Unit (MPU). Each function of the controller 12 and all functions included in the television receiver 100 are realized by execution of programs stored in storage media such as the storage 26 and the flash memory 28 by the controller 12 which is composed of a CPU or the like.

In this embodiment, the controller 12 performs channel scan. Details of the functions of the controller 12 and details of a channel scan process will be described later.

The tuner 14 selects a transmission channel of the broadcast signal received from the external antenna unit 80, by using the amplifier. The tuner 14 selects the transmission channel by a known method. For example, the tuner 14 includes an amplifier and amplifies the broadcast signal received by the antenna unit 80 by using the amplifier. The amplifier amplifies a broadcast signal, for example, at a frequency in a certain frequency band. The tuner 14 includes a low noise amplifier and amplifies the broadcast signal amplified by the amplifier with a low noise figure. The tuner 14 includes a bandpass filter for removing a signal other than a broadcast signal of a desired digital broadcast. The tuner 14 uses a bandpass filter to extract desired frequency components from the signal amplified by the low noise amplifier. The tuner 14 includes a variable gain amplifier, and amplifies the signal after being processed by the bandpass filter to a voltage that can be input to the demodulator 16. The tuner 14 transmits the signal thus generated to the demodulator 16.

The demodulator 16 demodulates the broadcast signal obtained from the tuner 14 to generate a digital signal. For example, the demodulator 16 converts the broadcast signal received from the tuner 14 into a digital signal using an A/D converter, demodulates the digital signal using a signal demodulator, corrects an error in the demodulated signal using an error correction processor, and outputs the corrected signal to the descrambling and demultiplexing processor 18.

The descrambling and demultiplexing processor 18 performs a process of descrambling the broadcast signal input from the demodulator 16, and splits the descrambled signal into a video signal, an audio signal, and other signals (such as subtitle data). The split video signal is output to the display processor 24, and the split audio signal is output to the audio processor 20.

The display processor 24 processes the signal input from at least one of the controller 12 and the descrambling and demultiplexing processor 18 such that the signal can be displayed on the display unit 70, so that display processor 24 generates display data to output the generated display data to the display unit 70.

The display unit 70 displays video on a display surface on the basis of the display data input from the display processor 24. The display unit 70 may be any device having a display function, and the type of hardware is not limited. For example, the display unit 70 can be composed of a device including display elements such as a liquid crystal display, a plasma display, an electro-luminescence (EL) display, and a driver circuit that drives the display elements on the basis of the display data input from the display processor 24.

The audio processor 20 generates audio data by processing a signal input from at least one of the controller 12 and the descrambling and demultiplexing processor 18, and outputs the generated audio data to the speaker 60. The audio processor 20 can be composed of an audio output processing circuit such as an amplifier.

The speaker 60 outputs audio to the outside on the basis of the audio data input from the audio processor 20.

The storage 26 is used as a main storage in which the controller 12 develops a control program. The storage 26 can be realized, for example, by a semiconductor read only memory (ROM), a random access memory (RAM), or the like.

The flash memory 28 is a non-volatile storage medium capable of storing various types of information, and is used as an auxiliary storage for the storage 26, which is the main storage. The flash memory 28 may be any other storage medium, as long as the flash memory 28 is a non-volatile memory such as a hard disk drive and a read only memory (ROM).

The high-speed digital I/F 30 is an interface that communicates with the transmitting and receiving module 40. In this embodiment, the high-speed digital I/F 30 receives a result on a transmitting and receiving state detected by the transmitting and receiving module 40 and transmits the result to the controller 12.

The channel scan data storage 51 is a storage medium that stores data used in the channel scan in this embodiment. In the example illustrated in FIG. 1, the channel scan data storage 51 is illustrated as an independent functional unit different from the storage 26, but the channel scan data storage 51 may be realized as a part of the storage 26. In this embodiment, the channel scan data storage 51 stores a channel scan result table and a registered channel table as data used in the channel scan.

The channel scan result table is a table that stores information on the result of the channel scan. In this embodiment, the channel scan result table stores channel information indicating each of channels in a predetermined range and a counter based on a determination result as to whether or not the channel is selectable, in association with each other. The channels in the predetermined range are, for example, physical channels in a range, which are subjects of the channel scan, and are stored in advance in the storage 26.

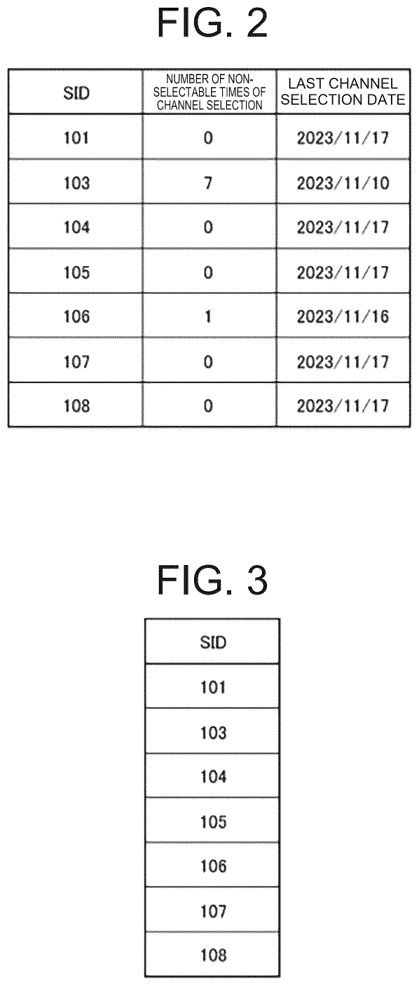

FIG. 2 is a diagram illustrating an example of the channel scan result table stored in the channel scan data storage 51. The channel scan result table illustrated in FIG. 2 stores the number of non-selectable times of channel selection and the last date of selection, in association with each service ID (SID).

The SID is an example of channel information. The channel information is not limited to the SID and may be other information as long as the channel information is information that can identify the channel.

The number of non-selectable times of channel selection is an example of a counter based on a result of determining whether a channel is selectable or not. Specifically, in this embodiment, the number of non-selectable times of channel selection is the number of times that a channel is determined not to be consecutively selectable by executing channel scan. The number of non-selectable times of channel selection is updated by a channel selection determiner 21 every time the channel scan is performed.

The last channel selection date is the date when the channel was last determined to be selectable by performing channel scan. The last channel selection date is updated by the channel selection determiner 21 each time channel scan is performed. The last channel selection date may include not only the date but also the time.

The registered channel table is a table in which selectable channels are registered. FIG. 3 is a diagram illustrating an example of the registered channel table stored in the channel scan data storage 51. As illustrated in FIG. 3, the registered channel table stores channel information for channels that are registered as selectable. Specifically, in the example illustrated in FIG. 3, the SID is stored as the channel information of the registered channel. Like the channel scan result table, the channel information is not limited to the SID and may be other information as long as the channel information is information that can identify the channel. The registered channel table is updated by the channel selection determiner 21 on the basis of the result of the channel scan.

Referring to FIG. 1 again, the channel scan data storage 51 includes a channel selection NG counter 52. The channel selection NG counter 52 is a type of data stored in the channel scan data storage 51. In this embodiment, the number of non-selectable times of channel selection illustrated in FIG. 2 corresponds to the channel selection NG counter 52.

The transmitting and receiving module 40 is a module that can transmit and receive signals. The transmitting and receiving module 40 is realized, for example, by a Wi-Fi (registered trademark) module, a Bluetooth (registered trademark) module, an infrared receiving module, or the like. The transmitting and receiving module 40 transmits and receives data of a user channel selection instruction and the like via a remote control and the like.

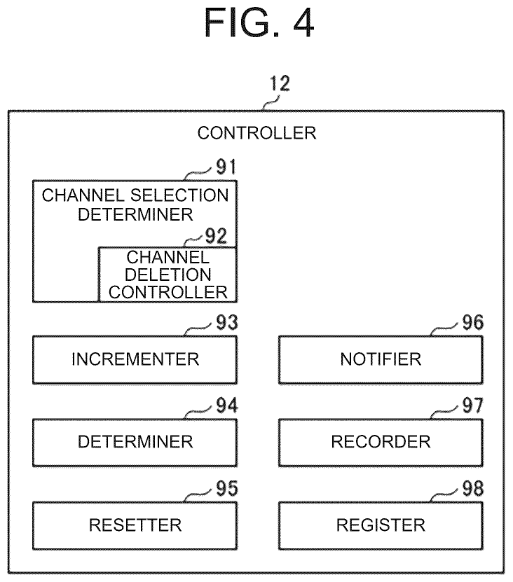

FIG. 4 is a functional block diagram illustrating a schematic configuration of the controller 12 in FIG. 1. As illustrated in FIG. 4, the controller 12 includes, as its functional units, a channel selection determiner 91, an incrementer 93, a determiner 94, a resetter 95, a notifier 96, a recorder 97, and a register 98. The controller 12 is configured to have functions of these functional units, for example. That is, the functions of these functional units are executed as parts of the functions of the controller 12.

The channel selection determiner 91 performs determination as to whether a channel is selectable. In this embodiment, the channel selection determiner 91 includes a channel deletion controller 92. The channel deletion controller 92 deletes channel information of a channel that is determined to satisfy a predetermined condition in channel scan.

Specifically, the channel deletion controller 92 deletes the channel information stored in various tables stored in the channel scan data storage 51, namely, channel information stored in the channel scan result table and the registered channel table described above. The predetermined condition is a condition under which it can be assumed that the channel cannot be selected for a permanent reason, and may be set appropriately. In this embodiment, the predetermined condition is a condition that the determiner 94 described later determines that a channel is not receivable. Therefore, in this embodiment, the channel deletion controller 92 deletes, from the registered channel table, a channel that is determined not to be receivable.

In addition, in a case where a channel for which the channel selection determiner 91 has performed determination as to whether or not the channel is selectable is not selectable, and there is a counter in a reset state for a channel other than the channel determined not to be selectable, the channel deletion controller 92 deletes, from the registered channel table, the channel that is determined not to be selectable.

In a case where the channel for which the channel selection determiner 91 has performed determination as to whether or not the channel is selectable is not selectable, the incrementer 93 increments the counter of the channel that is determined not to be selectable. For example, the incrementer 93 increments, by 1, the number of non-selectable times of channel selection associated with the SID of a channel determined not to be selectable in the channel scan result table.

A determiner 94 determines whether or not the counter exceeds a threshold value. The threshold value is a threshold value used to determine whether or not the channel cannot be selected due to a temporary cause. The threshold value is preset as an appropriate value that can determine whether or not the channel cannot be selected due to a temporary cause, and is stored in, for example, the storage 26.

In addition, in a case where the counter exceeds the threshold value, the determiner 94 determines that the channel on which the counter exceeds the threshold value is unavailable. The “unavailable” referred herein means that the channel cannot be selected due to a permanent reason, such as the termination of a broadcast service, rather than a temporary cause.

In a case where the channel determined by the channel selection determiner 91 as to whether or not the channel is selectable, the resetter 95 resets the counter of the channel determined to be selectable. In this embodiment, the resetter 95 resets the counter by setting the number of non-selectable times of channel selection indicating the counter to “0” in the channel scan result table in FIG. 2.

The notifier 96 notifies a user of information. The notification can be performed in any manner perceivable by the user. For example, the notifier 96 can notify the user by causing the speaker 60 to output audio or displaying information on the display unit 70.

In this embodiment, in a case where a channel determined by the channel selection determiner 91 as to whether or not the channel is selectable is not selectable and there is no counter in a reset state for a channel other than the channel determined not to be selectable, the notifier 96 notifies the user of a possibility that there is a problem with a television broadcast signal receiving environment.

In a case where the channel for which the channel selection determiner 91 has performed determination as to whether the channel is selectable is selectable, the recorder 97 records information regarding the time when the determination was performed in association with the channel determined to be selectable. In this embodiment, the recorder 97 records, as information regarding time, by updating the last channel selection date in the channel scan result table illustrated in FIG. 2. In a case where the last channel selection date includes time, the recorder 97 records the last channel selection date and the time as information regarding time.

In a case where the channel determined by the channel selection determiner 91 as to whether or not the channel is selectable is selectable and is not registered in the registered channel table, the register 98 registers, in the registered channel table, the channel determined to be selectable.

### Channel Scan

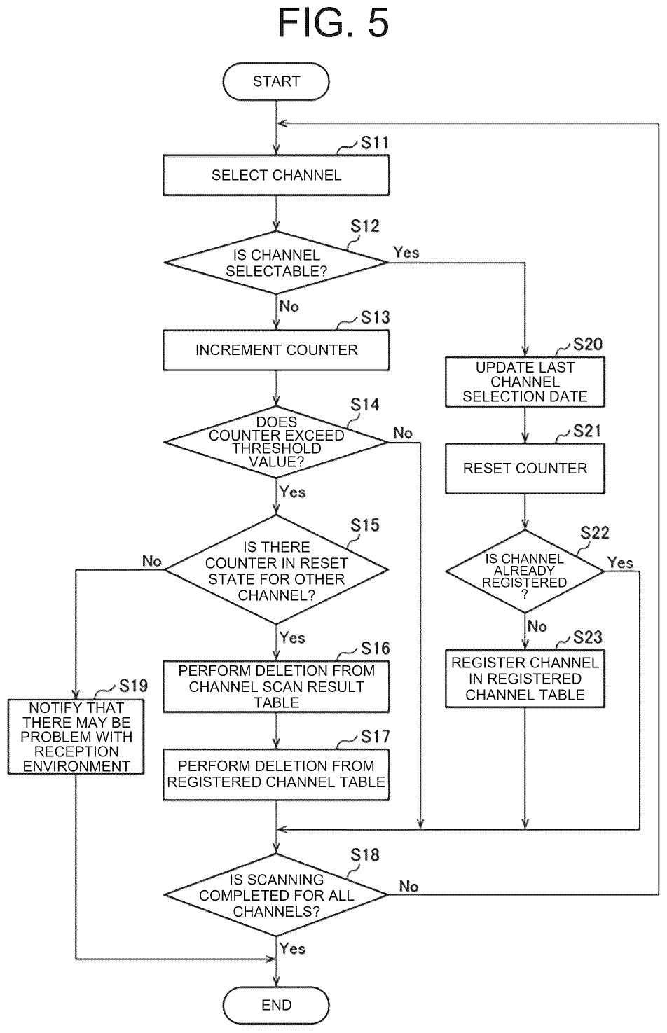

FIG. 5 is a flowchart illustrating an example of the channel scan process executed by the controller 12 in FIG. 1. The controller 12 executes the flow illustrated in FIG. 5, for example, periodically or irregularly. In this embodiment, the channel scan that the controller 12 performs periodically or irregularly is also referred to as automatic channel scan. The controller 12 may execute the flow illustrated in FIG. 5, for example, on the basis of predetermined operation input by a user.

In the channel scan process, the channel selection determiner 91 selects one of the channels in the predetermined range (Step S11).

The channel selection determiner 91 determines whether or not the channel selected in Step S11 is selectable, on the basis of the television broadcast signal received by the antenna unit 80, (Step S12). Whether or not the channel can be selected can be determined by a known method. For example, the channel selection determiner 91 determines whether or not the broadcast signal can be received normally by analyzing data of the broadcast signal. Whether or not the broadcast signal is received normally is determined by, for example, detection of a Bit Error Rate (BER), a reception C/N ratio, or the like.

In a case where the channel selection determiner 91 determines that the channel selected in Step S11 is selectable (Yes in Step S12), the recorder 97 updates the last channel selection date associated with the channel determined to be selectable, in the channel scan result table stored in the channel scan data storage 51 (Step S20). Specifically, the recorder 97 updates the last channel selection date by recording the date on which the channel was determined to be selectable in the last channel selection date associated with the SID of the channel determined to be selectable in the channel scan result table illustrated in FIG. 2, for example. Thus, the channel scan result table records the date on which the channel was last determined to be selectable for each channel.

In a case where the channel selection determiner 91 determines that the channel selected in Step S11 is selectable (Yes in Step S12), the resetter 95 resets a counter associated with the channel determined to be selectable in the channel scan result table stored in the channel scan data storage 51 (Step S21). In the example illustrated in FIG. 2, the resetter 95 resets the counter by setting the number of non-selectable times of channel selection indicating the counter to “0”. Therefore, for example, it is assumed that the channel selection determiner 91 determines that a channel represented by the SID “106” is selectable. In this case, in the example illustrated in FIG. 2, the number of non-selectable times of channel selection, which indicates a counter associated with the channel with the SID “106”, is “1”, and therefore the resetter 95 resets the counter by setting the number of non-selectable times of channel selection to “0”.

Furthermore, the register 98 determines whether or not the channel determined to be selectable in Step S11 is registered in the registered channel table (Step S22). The register 98 determines whether or not the SID of a channel that is determined to be selectable is stored in the registered channel table illustrated in FIG. 3, for example.

In a case where the register 98 determines that the channel determined to be selectable is registered in the registered channel table (Yes in Step S22), the channel selection determiner 91 determines whether or not scanning is completed for all channels in the predetermined range, that is, whether or not the determination as to whether or not the channel is selectable in Step S12 is completed (Step S18).

In a case where the channel selection determiner 91 determines that the scanning is completed for all channels in the predetermined range (Yes in Step S18), the flow in FIG. 4 is ended.

On the other hand, in a case where the channel selection determiner 91 determines that scanning is not completed for all channels in the predetermined range (No in Step S18), that is, in a case where the channel selection determiner 91 determines that scanning is not performed for some of the channels in the predetermined range, the process proceeds to Step S11. In this case, in Step S11, the channel selection determiner 91 selects a channel that is not scanned from among the channels in the predetermined range, and performs a subsequent process.

In a case where the register 98 determines that the channel determined to be selectable is not registered in the registered channel table (No in Step S22), the register 98 registers the channel determined to be selectable in the registered channel table (Step S23). Consequently, it is possible to register a channel that is determined to be newly selectable by the channel scan. Then, the channel selection determiner 21 proceeds to Step S18.

In Step S12, in a case where the channel selection determiner 91 determines that the channel selected in Step S11 is not selectable (No in Step S12), the incrementer 93 increments the counter associated with the channel determined not to be selectable in the channel scan result table stored in the channel scan data storage 51 (Step S13). For example, it is assumed that the channel selection determiner 21 determines that a channel represented by the SID “101” is not selectable. In this case, as illustrated in FIG. 2, the number of non-selectable times of channel selection, which indicates a counter associated with the channel with the SID “101”, is “0”, and therefore the incrementer 93 increments the number of non-selectable times of channel selection to “1”. For example, it is assumed that the channel selection determiner 21 determines that a channel represented by the SID “103” is not selectable. In this case, in the example illustrated in FIG. 2, the number of non-selectable times of channel selection, which indicates a counter associated with the channel with SID “103”, is “7”, and therefore the incrementer 93 increments the number of non-selectable times of channel selection to “8”.

Next, the determiner 94 determines whether or not the counter incremented in Step S13 exceeds a predetermined threshold value (Step S14). In this embodiment, it is assumed that the predetermined threshold value is, for example, “7”. Even in a case where the counter associated with the channel with the SID “101” is incremented to “1”, the counter does not exceed the predetermined threshold value “7”. Therefore, the determiner 94 determines that counter does not exceed the predetermined threshold value. On the other hand, in a case where the counter associated with the channel with the SID “103” is incremented to “8”, the counter exceeds the predetermined threshold value “7”. In this case, the determiner 94 determines that the counter exceeds the predetermined threshold value. For example, in a case where channel scan is performed once a day, and in a case where it is determined that the channel is not selectable for one consecutive week, the counter exceeds the predetermined threshold value.

In a case where the determiner 94 determines that the counter does not exceed the predetermined threshold value (No in Step S14), the process proceeds to Step S18.

In a case where the determiner 94 determines that the counter exceeds the predetermined threshold value (Yes in Step S14), the determiner 94 determines whether or not there is a counter that is in a reset state and is associated with channel information indicating a channel other than the channel determined not to be selectable in the channel scan result table (Step S15). For example, it is assumed that the counter associated with the channel with the SID “103” is incremented to “8” to exceed the threshold value “7”. In this case, the determiner 94 determines whether or not there is a channel other than the SID “103” included in the channel scan result table whose number of non-selectable times of channel selection is “0”.

In a case where the determiner 94 determines that there is no counter that is associated with the channel information indicating another channel and is in a reset state (No in Step S15), the notifier 96 notifies the user of a possibility that there is a problem with a television broadcast signal receiving environment. (Step S19). For example, in the channel scan result table illustrated in FIG. 3, in a case where the number of non-selectable times of channel selection associated with an SID is 1 or more for all other channels, there is no counter in the reset state. This state occurs because all channels are determined not to be selectable in Step S12 and the counters are incremented in Step S13. In other words, this state indicates that all channels are not selectable. However, it is considered that a state in which all channels are not selectable is unlikely to occur in reality when the broadcast signal is sent from a broadcast station. Therefore, in this case, the notifier 96 notifies the user of a possibility that there is a problem with a reception environment. Examples of the problem with the reception environment include a poor antenna connection, a change in the antenna direction, and turned off of a parabolic antenna.

The notification enables the user to become aware of a possible problem in the reception environment and to take measures to solve such a problem. In a case where the notifier 96 notifies of a possibility that there is a problem with the reception environment, the flow in FIG. 4 is ended. Until the problem with the reception environment is resolved, other channels remain non-selectable.

On the other hand, in a case where the determiner 94 determines that there is a counter that is associated with channel information indicating another channel and is in a reset state (Yes in Step S15), this means that there is another channel that can be selected. The state in which the counter is reset is realized because it is determined in Step S12 that the channel can be selected, and the counter is reset in Step S21. For example, as illustrated in FIG. 2, in a case where the number of non-selectable times of channel selection for at least one channel is 0, this means that the channel for which the number of non-selectable times of channel selection is 0 is selectable.

In this case, the channel that is determined not to be selectable in Step S12 and whose counter is determined to have exceeded the threshold value in Step S14 is determined not to be selectable for the number of consecutive threshold times of channel selection in a plurality of times of channel scan. This is not a temporary cause, but rather a permanent reason, such as the termination of broadcast services, so that it is estimated that the channel is not selectable.

Therefore, in a case where the determiner 94 determines that there is the counter that is associated with the channel information indicating another channel and is in the reset state (Yes in Step S15), a channel deletion controller 22 in the channel selection determiner 21 deletes the channel that is determined not to be selectable in Step S12 from the channel scan result table (Step S16). In this case, for example, in the channel scan result table, the SID of the channel that is determined not to be selectable in Step S12 and all information associated with the SID are deleted.

Furthermore, in a case where the determiner 94 determines that there is the counter that is associated with the channel information indicating another channel and is in the reset state (Yes in Step S15), the channel deletion controller 22 in the channel selection determiner 21 deletes the channel that is determined not to be selectable in Step S12 from the registered channel table (Step S17). In this case, for example, in the registered channel table, the SID of the channel that is determined not to be selectable in Step S12 is deleted. Consequently, any channel registration that is no longer selectable due to a permanent reason such as the termination of broadcast services is deleted from the television receiver 100. Thus, the main system 10, which functions as an information processing device, can more appropriately manage a channel registration state in accordance with the situation of broadcast services.

The channel selection determiner 21 deletes the channel in Step S16 and Step S17 and then proceeds to Step S18.

Thus, in the television receiver 100 according to this embodiment, in a case where the counter incremented by the incrementer 93 exceeds the threshold value, the channel for which the counter exceeds the threshold value is determined not to be receivable. Consequently, in a case where the channel is not selectable due to a temporary cause, the channel is not determined not to be receivable, but in a case where the channel is selectable for a permanent reason, the channel is determined not to be receivable. Therefore, the television receiver 100 can more appropriately manage the channel registration state in accordance with the situation of broadcast services.

In the above embodiment, the television receiver 100 performs the channel scan process using the channel scan result table and the registered channel table stored in the storage 26. However, the television receiver 100 is not necessarily use these tables. The television receiver 100 can perform the channel scan process by using at least a counter.

In addition, in the above embodiment, in Step S16 and Step S17, a channel that is determined not to be selectable is deleted. In a case where a channel is deleted in this manner, information related to the channel may be deleted. For example, information related to a channel, such as the EPG, the channel number assigned to the remote control (remote control number), and reservation information related to the channel, may be deleted.

### Recovery of Channel

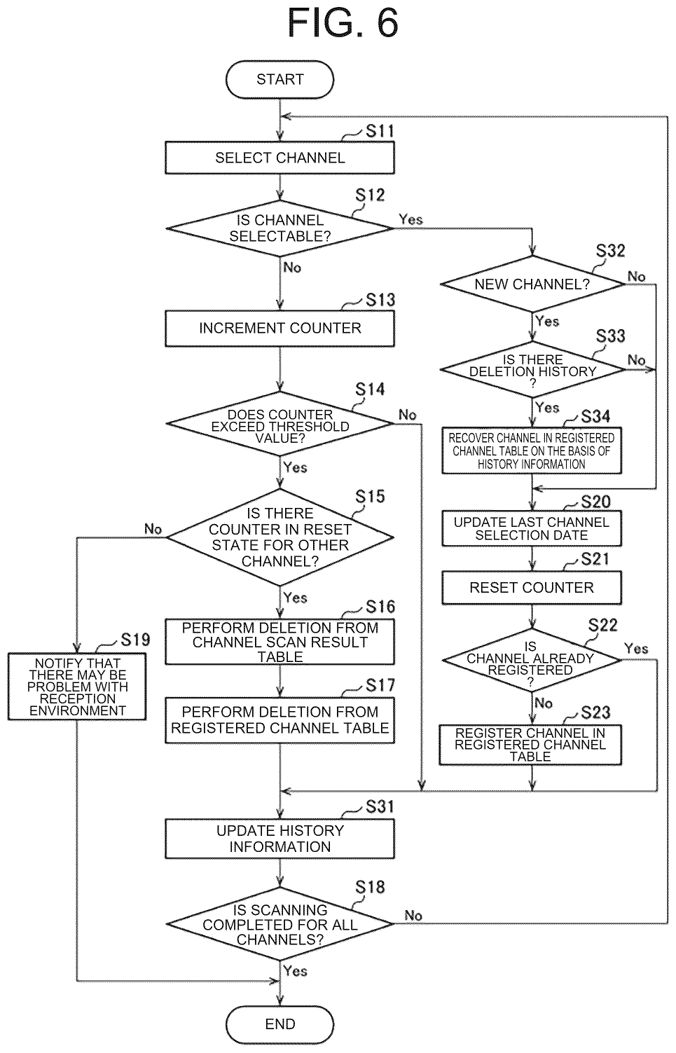

In the above embodiment, the controller 12 may recover the channel deleted in Step S17 of FIG. 5 to the registered channel table under a predetermined condition. The predetermined condition is, for example, that a certain channel is determined to be selectable in a subsequent channel scan by the channel selection determiner 91 after the certain channel has been deleted from the registered channel table. An example of a process for recovering a channel will be described with reference to FIG. 6.

FIG. 6 is a flowchart illustrating an example of the channel recovery process executed by the controller 12 in FIG. 1. In the flowchart of FIG. 6, Step S11 to Step S17 are the same as Step S11 to Step S17 described in FIG. 5, respectively, and therefore detailed description thereof will be omitted herein.

In a case where the channel deletion controller 22 deletes, from the registered channel table, a channel that is determined not to be selectable, the channel deletion controller 22 stores history information regarding the deletion of the channel in the history information table (Step S31). Herein, the history information table is a table that stores history information regarding the deletion of a channel from the registered channel table. The history information table is stored, for example, in the channel scan data storage 51. The history information table may be stored in a storage medium other than the channel scan data storage 51.

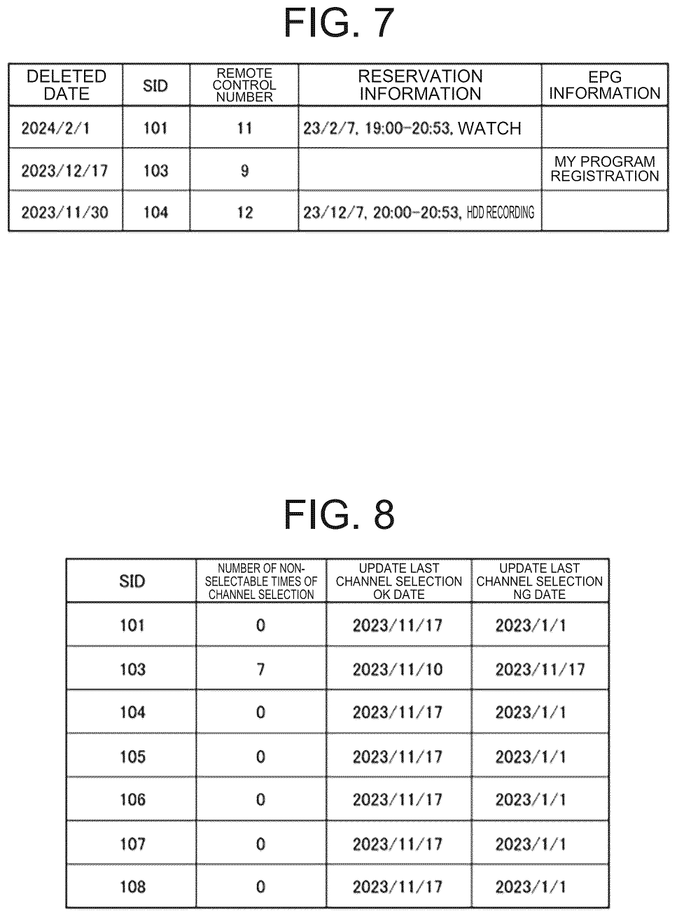

FIG. 7 is a diagram illustrating an example of a history information table stored in the channel scan data storage 51 in FIG. 1. As illustrated in FIG. 7, the history information table contains history information regarding channel deletion. Specifically, the history information table stores a deleted date, SID, and additional information as history information, in association with each other.

The deleted date indicates the date on which the channel was deleted from the registered channel table. The SID indicates the SID of a channel that has been removed from the registered channel table. The additional information is appropriate information related to the channel deleted from the registered channel table, and includes a remote control number, reservation information, and EPG information in the example illustrated in FIG. 7. The remote control number is, for example, a remote control number that a user assigns to a channel. The reservation information is, for example, information regarding watch or recording reservation set by a user. The EPG information is, for example, information that a user has registered in the EPG. However, the additional information is not limited to the remote control number, the reservation information, and the EPG information, and may include other information.

Also, in the example illustrated in FIG. 7, the history information table stores history information regarding the deletion of a channel from the registered channel table, but the history information table may further store history information regarding the registration of a channel in the registered channel table.

Referring again to FIG. 6, in Step S31, the channel deletion controller 22 stores history information regarding the deletion of the channel deleted from the registered channel table in Step S17 in, for example, the history information table illustrated in FIG. 7. Consequently, the information regarding the deleted channel is stored in the history information table. Then, the process proceeds to Step S18. Step S18 is the same as Step S18 described in FIG. 5, and therefore detailed description thereof will be omitted herein.

In the channel recovery process, in a case where the channel selection determiner 91 determines that the channel selected in Step S11 is selectable (Yes in Step S12), the channel selection determiner 91 determines whether or not the channel determined to be selectable is a new channel that is not registered in the registered channel table (Step S32). The channel selection determiner 91 can determine whether or not the channel that is determined to be selectable is a new channel, for example, by referring to the registered channel table stored in the channel scan data storage 51.

Specifically, the channel selection determiner 91 determines whether or not a channel that is determined to be selectable is a new channel, for example, on the basis of whether or not the SID of the channel that is determined to be selectable is registered in the registered channel table illustrated in FIG. 3. In a case where the SID of the channel that is determined to be selectable is registered in the registered channel table, the channel selection determiner 91 determines that the channel that is determined to be selectable is not a new channel. On the other hand, in a case where the SID of the channel determined to be selectable by the channel selection determiner 91 is not registered in the registered channel table, the channel selection determiner 91 determines that the channel determined to be selectable by the channel selection determiner is a new channel.

In a case where the channel selection determiner 91 determines that the channel determined to be selectable by the channel selection determiner 91 is not a new channel (No in Step S32), that is, in a case where the channel determined to be selectable by the channel selection determiner 91 has already been registered, the process proceeds to Step S20. Processes subsequent to Step S20 are the same as those described with reference to FIG. 5, and therefore detailed description thereof will be omitted herein.

On the other hand, in a case where the channel selection determiner 91 determines that the channel that the channel selection determiner 91 determines to be selectable is a new channel (Yes in Step S32), that is, in a case where the channel that the channel selection determiner 91 determines to be selectable is not registered in the registered channel table, the channel that the channel selection determiner 91 determines whether or not there is a deletion history for this channel (Step S33). Specifically, the channel selection determiner 91 determines whether or not the SID of the channel that the channel selection determiner 91 determines to be selectable exists in the history information table illustrated in FIG. 7. In a case where the SID of the channel that is determined to be selectable exists in the history information table, the channel selection determiner 91 determines that there is a deletion history for the channel that is determined to be selectable. On the other hand, in a case where the SID of the channel determined to be selectable does not exist in the history information table, the channel selection determiner 91 determines that there is no deletion history for the channel determined to be selectable.

In a case where the channel selection determiner 91 determines that there is no deletion history for the channel that the channel selection determiner 91 determines to be selectable (No in Step S33), the process proceeds to Step S20. In this case, the channel that is determined to be selectable is not registered in the registered channel table, and does not exist in the history information table either, and therefore has never been registered in the registered channel table in the past. Therefore, in the subsequent Step S23, the channel is registered in the registered channel table as a completely new channel.

On the other hand, in a case where the channel selection determiner 91 determines that there is the deletion history for the channel that channel selection determiner 91 determines to be selectable (Yes in Step S33), the register 98 recovers this channel to the registered channel table on the basis of the history information stored in the history information table (Step S34). Herein, recovering the channel to the registered channel table means registering the channel in the registered channel table and restoring the information associated with the channel to its original state. Specifically, as illustrated in FIG. 7, in a case where the remote control number, the reservation information, and the EPG information are associated with the channel SID, the register 98 recovers the remote control number, the reservation information, and the EPG information to the same state as when the channel was registered in the registered channel table. In a case where the remote control number, the reservation information, and the EPG information are stored in a table other than the registered channel table, for example, this information is stored again in the other table.

Thus, in the channel recovery process, in a case where the channel selection determiner 91 determines that a channel deleted from the registered channel table is selectable after being deleted from the registered channel table, the register 98 recovers the channel to the registered channel table. Consequently, in a case where a channel enters from being non-selectable to being selectable, not only the channel is registered in the registered channel table, but previously registered information associated with the channel is also restored to its original state. Thus, the information previously associated with the channel is automatically restored, and therefore the user does not need to set the information again when the channel is registered again in the registered channel table. Therefore, by the channel recovery process, it is possible to improve user convenience.

### Channel Scan Based on User Operation

In FIG. 5, the automatic channel scan that periodically or irregularly performed by the controller 12 is described. However, the channel scan is not limited to this and may be performed, for example, on the basis of channel selection operation by a user. That is, the channel selection determiner 91 may perform determination as to whether or not a channel is selectable on the basis of the channel selection operation by the user. The channel scan that is performed on the basis of the channel selection operation by the user will be hereinafter described.

In channel scan that is performed on the basis of the channel selection operation by the user, a channel scan result table stores a last channel selection OK date and a last channel selection NG date instead of the last channel selection date. FIG. 8 illustrates another example of a channel scan result table stored in the channel scan data storage 51 in FIG. 1. Specifically, FIG. 8 illustrates an example of a channel scan result table used in channel scan performed on the basis of a user's channel selection operation.

As illustrated in FIG. 8, the channel scan result table stores the number of non-selectable times of channel selection, the last channel selection OK date, and the last channel selection NG date in association with the SID. The last channel selection OK date is the date on which the channel was last determined to be selectable by performing channel scan. The last channel selection NG date is the date on which the channel was last determined not to be selectable by performing channel scan. Each time channel scan is performed, either the last channel selection NG date or the last channel selection NG date is updated by the channel selection determiner 21 in accordance with the result of the channel scan. The last channel selection OK date and the last channel selection NG date may include not only the date but also the time.

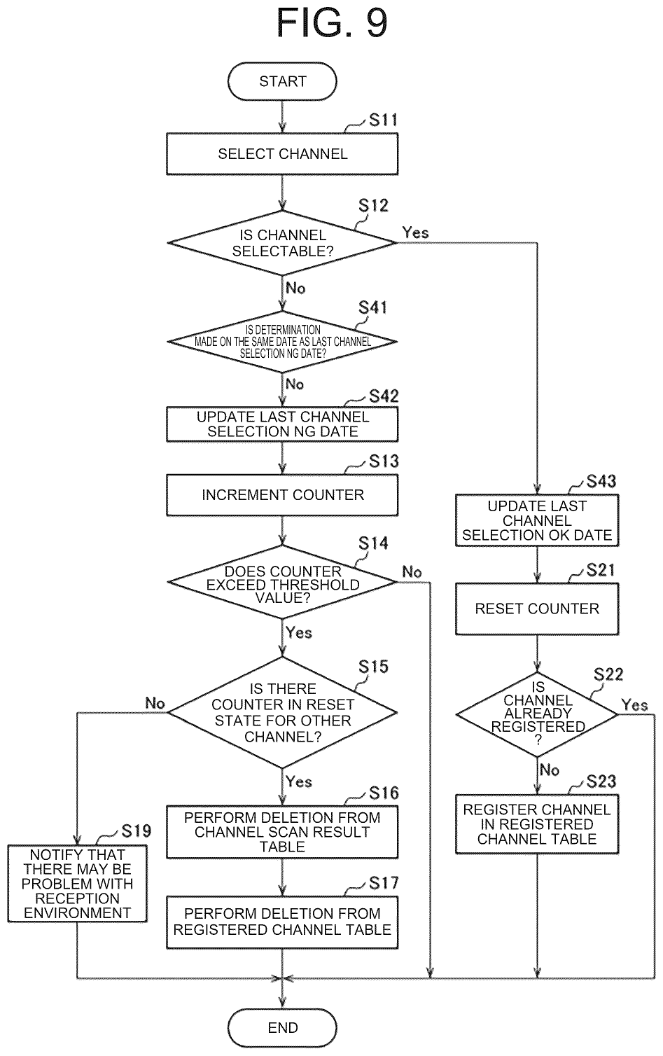

FIG. 9 is a flowchart illustrating another example of the channel scan process executed by the controller 12 in FIG. 1. Specifically, FIG. 9 is a flowchart illustrating an example of a channel scan process that is performed on the basis of channel selection operation by a user.

The flowchart illustrated in FIG. 9 is executed in a case where a user selects a channel using, for example, a remote control or a control button (not illustrated) on a television receiver. The channel selection determiner 91 selects the channel specified by the user's channel selection operation (Step S11).

The channel selection determiner 91 determines whether or not the channel selected in Step S11 is selectable (Step S12). Step S12 is the same as Step S12 described in FIG. 5, and therefore detailed description thereof will be omitted herein.

In a case where the channel selection determiner 91 determines that the selected channel is not selectable (No in Step S12), the channel selection determiner 91 determines whether or not the current determination is within a predetermined time range since the last time that the channel was determined not to be selectable. The channel selection determiner 91 can determine whether or not the current determination is within the predetermined time range since the last time that the channel was determined not to be selectable, for example, by referring to the last channel selection NG date in the channel scan result table illustrated in FIG. 8.

Herein, the predetermined time range can be determined appropriately. For example, the predetermined time range can be a predetermined number of hours (e.g., 24 hours) or days (e.g., one day) since the channel was last determined not to be selectable. In this case, in a case where the current determination is made within a predetermined time or number of days since the channel was last determined not to be selectable, the channel selection determiner 91 determines that the channel is within the predetermined time range. Alternatively, the predetermined time range can be the same date as the date on which the channel was last determined not to be selectable. In this case, in a case where the current determination is made on the same day as the day on which the channel was last determined not to be selectable, the channel selection determiner 91 determines that the channel is within the predetermined time range. Herein, the predetermined time range is the same day as the last day that the channel was determined not to be selectable. Therefore, in a case where the channel selection determiner 91 determines that the selected channel is not selectable (No in Step S12), the channel selection determiner 91 determines whether or not the current determination is made on the same day as the day on which the channel was last determined not to be selectable (Step S41).

In a case where the channel selection determiner 91 determines that the current determination is within the predetermined time range since the last time that the channel was determined not to be selectable, that is, in a case where the current determination is made on the same day as the last time that the channel was determined not to be selectable (Yes in Step S41), this flow ends. In other words, in this case, the incrementer 93 does not increment the counter even in a case where the channel is determined not to be selectable again within a predetermined time range (herein, the same day). Consequently, it is possible to prevent the counter from being incremented excessively and therefore prematurely deleted, even in a case where the channel is determined not to be selectable within a short period of time.

On the other hand, in a case where the channel selection determiner 91 determines that the current determination is not within the predetermined time range since the last time that the channel was determined not to be selectable, that is, in a case where the current determination is not made on the same day as the day on which the channel was last determined not to be selectable (No in Step S41), the recorder 97 updates the last channel selection NG date associated with the channel determined not to be selectable in the channel scan result table stored in the channel scan data storage 51 (Step S42).

Then, Step S13 to Step S19 are executed. Step S13 to Step S19 are the same as Step S13 to Step S19 illustrated in FIG. 5, and therefore will not be described in detail herein. However, the flow in FIG. 9 is performed on the basis of the channel selection operation by the user, and therefore channel scan is not performed for channels that are not selected by the user. Therefore, the determination in Step S18 is not performed and this flow ends.

Thus, in a case where it is determined that the current determination is not within the predetermined time range since the last time that the channel was determined not to be selectable, the last channel selection NG date is updated (Step S42), and the counter associated with this channel is incremented (Step S13).

On the other hand, in a case where the channel selection determiner 91 determines that the selected channel is selectable (Yes in Step S12), the recorder 97 updates the last channel selection OK date associated with the channel determined to be selectable in the channel scan result table stored in the channel scan data storage 51 (Step S43).

Then, Step S21 to Step S23 are executed. Steps S21 to S23 are the same as Steps S21 to S23 illustrated in FIG. 5, and therefore will not be described in detail herein.

Thus, on the basis of the channel selection operation by the user, the determination is made as to whether the channel is selectable.

In addition, the controller 12 may execute both the flowchart illustrated in FIG. 5 and the flowchart illustrated in FIG. 9. That is, the controller 12 may perform the automatic channel scan described with reference to FIG. 5, and in a case where the channel selection operation is input by the user, the controller 12 may perform the channel scan described with reference to FIG. 9 on the basis of the channel selection operation. In this case, the channel scan result table illustrated in FIG. 8 is shared between the flowchart illustrated in FIG. 5 and the flowchart illustrate in FIG. 9. That is, the channel scan result table illustrate in FIG. 8 is also updated by the automatic channel scan process.

In addition, the process of Step S41 in FIG. 9 may also be performed in the automatic channel scan described with reference to FIG. 5. Consequently, it is possible to prevent the counter from being incremented excessively and therefore prematurely deleted, even in a case where the automatic channel scan is performed a plurality of times on the same day.

Although the present disclosure is described on the basis of the drawings and the embodiment, it should be noted that various modifications and corrections can be easily made by those skilled in the art based on the present disclosure. Therefore, please note that these modifications and corrections are included within the scope of the present disclosure. For example, the functions included in each functional unit or step can be rearranged so as not to cause logical inconsistencies, and a plurality of functional units or steps can be combined into one or divided.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An information processing device comprising:
a channel selection determiner that performs determination as to whether or not a channel is selectable;
an incrementer that, in a case where a channel, on which the determination is made, is not selectable, increments a counter of the channel determined not to be selectable; and
a determiner that, in a case where the counter exceeds a threshold value, determines that a channel, for which the counter exceeds the threshold value, is not receivable.

2. The information processing device according to claim 1, further comprising
a channel scan data storage that stores a registered channel table in which a selectable channel is registered; and
a channel deletion controller that deletes the channel determined not to be receivable, from the registered channel table.

3. The information processing device according to claim 2, further comprising
a resetter that, in a case where a channel, on which the determination is made, is selectable, resets a counter of the channel determined to be selectable.

4. The information processing device according to claim 3, further comprising
a notifier that notifies a user of a possibility that there is a problem with a television broadcast signal receiving environment in a case where the channel, on which the determination is made, is not selectable and there is no counter in a reset state for a channel other than the channel determined not to be selectable.

5. The information processing device according to claim 3, wherein
in a case where the channel, on which the determination is made, is not selectable and there is a counter in a reset state for a channel other than the channel determined not to be selectable, the channel deletion controller deletes the channel determined not to be selectable, from the registered channel table.

6. The information processing device according to claim 1, further comprising
a recorder that, in a case where a channel, on which the determination is made, is selectable, records information regarding time when the determination is performed in association with the channel determined to be selectable.

7. The information processing device according to claim 2, further comprising
a register that, in a case where the channel, on which the determination is made, is selectable, and is not registered in the registered channel table, registers, in the registered channel table, the channel determined to be selectable.

8. The information processing device according to claim 2, wherein
the channel scan data storage further stores history information regarding deletion of the channel determined not to be receivable from the registered channel table, and
the information processing device further comprises
a register that recovers a channel deleted from the registered channel table, to the registered channel table, in a case where the channel selection determiner determines that the channel deleted from the registered channel table is selectable after being deleted from the registered channel table.

9. The information processing device according to claim 1, wherein
the channel selection determiner performs the determination by automatic channel scan performed periodically or irregularly.

10. The information processing device according to claim 1, wherein
the channel selection determiner performs the determination on the basis of channel selection operation of the channel by a user.

11. The information processing device according to claim 1, wherein
in a case where the incrementer increments the counter of the channel determined not to be selectable, even in a case where the channel is determined not to be selectable again within a predetermined time range, the incrementer does not increment the counter.

12. A television receiver comprising the information processing device according to claim 1.

13. An information processing method to be performed by an information processing device, the information processing method comprising:
performing determination as to whether or not a channel is selectable;
in a case where a channel, on which the determination is made, is not selectable, incrementing a counter of the channel determined not to be selectable; and
in a case where the counter exceeds the threshold value, determining that a channel, for which the counter exceeds a threshold value, is not receivable.
